(19) United States
(12) Patent Application Publication
(10) Pub. No.: US 2025/0021335 A1
(43) Pub. Date: Jan. 16, 2025

(54) QUANTUM DATABASE INSERT OPERATIONS SYSTEM

(71) Applicant: Abu Dhabi University, Abu Dhabi (DE)

(72) Inventors: Hichem El Euch, Abu Dhabi (AE); Mohammed Abdellatif Abdelaal Zidan, Assuit (EG); Montasir Yousouf Abdallah Qasymeh, Abu Dhabi (AE)

(73) Assignee: Abu Dhabi University, Abu Dhabi (AE)

(21) Appl. No.: 18/221,261

(22) Filed: Jul. 12, 2023

(51) Int. Cl. G06F 9/30; G06N 10/20; G06N 10/40

(52) U.S. Cl. CPC G06F 9/30098; G06N 10/20; G06N 10/40

(57) ABSTRACT

A quantum method initializes three registers in a quantum circuit. The quantum method determines a value of αₖ. The quantum method applies a set of size n of 3-qubit Toffoli gates. The quantum method then applies a S-operator. The quantum method then applies a n+1-qubit Toffoli gate. The quantum method then executes an IO Operator. The quantum method then applies the n+1-qubit Toffoli gate. The quantum method then applies the S-operator. The quantum method then applies a set of size n of 3-qubit Toffoli gates so as to store new input data. The quantum method adds new data into a uniform superposition QDB, or adds new data into a weighted superposition QDB.

### BACKGROUND

Databases are used in various computing systems to store information. The main operations conducted on databases to perform transactions include insert operations, update operations, delete operations, and search operations. Currently, there are no effective systems that can provide such operations for databases associated with quantum computing systems.

### BRIEF DESCRIPTION OF DRAWINGS

FIG. 1 is a diagram of an example system;

FIG. 2 is a diagram of an example quantum circuit;

FIG. 3 is a diagram of an example table;

FIG. 4 is a diagram of an example graph;

FIG. 5 is a diagram of an example graph;

FIG. 6 is a diagram of an example computing device; and

FIG. 7 is a diagram of an example computing device.

### DETAILED DESCRIPTION OF PREFERRED EMBODIMENTS

The following detailed description refers to the accompanying drawings. The same reference numbers in different drawings may identify the same or similar elements.

Systems, devices, and/or methods described herein may provide for one or more quantum circuit systems that provided for database search, delete, update, and/or insert operations. In embodiments, one or more circuits may be used to conduct search, delete, update, and/or insert operations in a quantum database. In embodiments, one particular quantum circuit may be a quantum insert circuit which may insert/append new data in a quantum database (i.e., QDB) to construct a uniform superposition QDB or a weighted superposition QDB.

Accordingly, the systems, devices, and/or methods described herein can be used to insert a greater amount of data into a database system, which cannot be achieved using non-quantum computers or other systems. In embodiments, the one or more quantum circuits provide for a more efficient insertion of information from one or more databases and can overcome issues of requiring more time associated with non-quantum systems. In embodiments, the insert operation may have a database system that is integrated with AI. Grover's algorithm, which is a quantum search algorithm, that reduces the search process within a database system of O(\sqrt{N}) (where N is the number of database items, compared with traditional algorithms that need O(N)). Thus, quantum computers have a significantly greater speed (such as a quadratic speed) to perform such search operations when compared to a non-quantum computer.

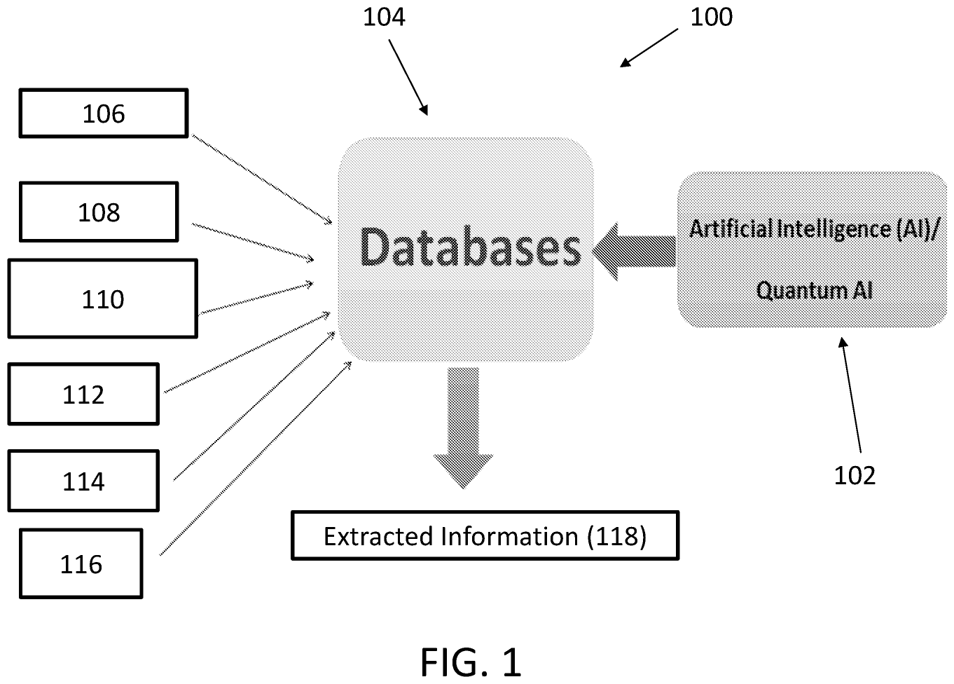

FIG. 1 shows an example diagram 100 of using quantum circuit system in combination with a database. As shown in FIG. 1, system 102 may describe the one or more particular quantum circuits for conducting database search, delete, update, and/or insert operations. In FIG. 1, database 104 may include one or more databases that may obtain information from one or more devices (device 106, 108, 110, 112, 114, and/or 116) that may be associated with different computer applications and may also be associated with different systems. As such, system 102 may be used to extract information 118 from database 104 more efficiently than other systems.

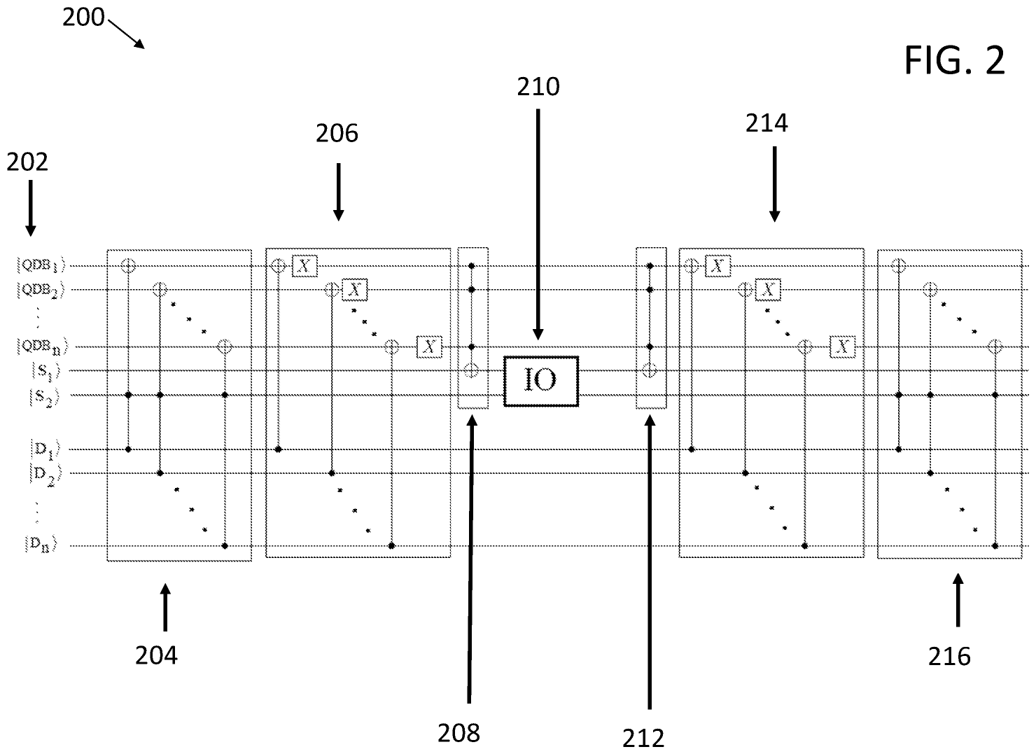

FIG. 2 is an example quantum circuit 200. In embodiments, quantum circuit 200 may be used to conduct an Insert Operation on a particular database (e.g., database 104). In embodiments, for quantum circuit 200 to conduct the Insert Operation, an algorithm may be used to store classical data in a QDB (quantum database) system. In embodiments, to perform the algorithm, the unitary operator IO is used and is defined as the following matrix;

$$IO = ( \begin{matrix}1 & 0 & 0 & 0 \\ 0 & 1 & 0 & 0 \\ 0 & 0 & g & h \\ 0 & 0 & - h & g\end{matrix} )$$

In embodiments, if it is required to store a uniform superimposition QDB, parameters g and h are initialized as follows in equation (1):

$$g = \sqrt{\frac{{2}^{n} - k}{1 + {2}^{n} - k}} and h = \sqrt{\frac{1}{1 + {2}^{n} - k}} , \qquad ( 1 )$$

In embodiments, where k=1, 2, 3, . . . , 2ⁿ−1. In embodiments, if it is required to store a weighted superposition QDB then the parameters are given by equation (2):

$${h}_{k} = \frac{\sqrt{\frac{M - {α}_{k}}{M}}}{{a}_{k - 1}} and {g}_{k} = \sqrt{1 - {b}_{k}^{2}} and {g}_{0} = 1 \qquad ( 2 )$$

FIG. 2 describes an invented quantum circuit of the insert operation for storing new information in the QDB. At step 0, quantum circuit 200 is initialized from three registers |QDB [symbol] , |S [symbol] , and |D [symbol] . In embodiments, the register |D [symbol] represents the input register which is of size n qubits. In embodiments, the register |D [symbol] carries new data which is required to be inserted in the quantum database (QDB). In embodiments, the register |QDB [symbol] represents a register of n qubits initialized with the vacuum state |000 . . . 0 [symbol] , which stores the quantum database in the quantum database system. In embodiments, the register |S [symbol] represents a two-qubit quantum control register initialized with state |01 [symbol] , where the state |01 [symbol] , for register |S [symbol] is used to mark the vacuum state |000 . . . 0 [symbol] . And initialize the counter k to be k=1.

At step 1 (202), if the given/calculated value of αₖ satisfies that αₖ=M−Σ_{i=1,k-1}αᵢ=1, then apply step 2 (204) only and terminate the algorithm; else apply steps 2-9. In embodiments, M represents the number of states, data items, which are required to be stored in the QDB, has a weight

$$\sqrt{\frac{{α}_{k}}{M}}$$

such that M may be equal or not equal 2ⁿ, αₖ=2ⁿ−k in equation (1), noted above. In embodiments, the value of M depends on given value that is defined by the user or a computer application program in equation (2) as noted above.

At step 2 (204): a set of size n of 3-qubit Toffoli gates are applied to store the new input data that is carried via the state of the register |D [symbol] into the vacuum state of register |QDB [symbol] .

At step 3 (206), quantum circuit 200 may apply the S-operator which consists of n of CNOT gates, and n of X gates. In embodiments, each CNOT gate is applied on each two qubits of the registers |D_i [symbol] , and |QDB_i [symbol] , where i=1, 2, . . . , n such that the control qubit is |D_i [symbol] and the target qubit is |QDB_i [symbol] . In embodiments, each gate of n X gates is applied on the qubits of the register |QDB_i [symbol] . In embodiments, step 3 (206) transforms the state of the new current inserted data to state |111 . . . 1 [symbol] .

At step 4 (208), the n+1-qubit Toffoli gate is applied by quantum circuit 200 such that the control qubits are the qubits of the register |QDB [symbol] , and the target qubit is |S_1 [symbol] . In embodiments, step 4 (208) marks by entanglement the new inserted state that is stored in the register |QDB [symbol] .

At step 5 (210), the IO operator is executed by quantum circuit 200. In embodiments, if it is required to construct a uniform superposition QDB then the operator IO is applied with the parameters of equation (1), described above. Conversely, in embodiments, if it is required to construct a uniform superposition QDB then the operator IO is applied with the parameters of equation (2) as described above.

At step 6 (212), step 4 is repeated. In embodiment; step 6 (212) undoes the effect of step (4) because the inverse of step 4 is performed by applying the same gate or it is decomposition. In other words, step 6 (212) removes the marking step that is done in step 4.

At step 7 (214), step 3 is repeated. In embodiments, step 7 (214) undoes the effect of step 3 because the inverse of step 3 is performed by applying the same gate.

At step 8 (216), step 2 is repeated. In embodiments, step 8 (216) makes the state of the register |D [symbol] which is entangled with state |01 [symbol] , of the register |S [symbol] , go to the vacuum state |000 . . . 0 [symbol] to be ready for storing new state(s).

At step 9, In embodiments, if it is required to store a uniform superposition QDB then k=k+1 in equation (1), described above, and go to step 2 (204). In embodiments, if it is required to store a weighted superposition QDB then receive α_k as input and go to step 2 (204).

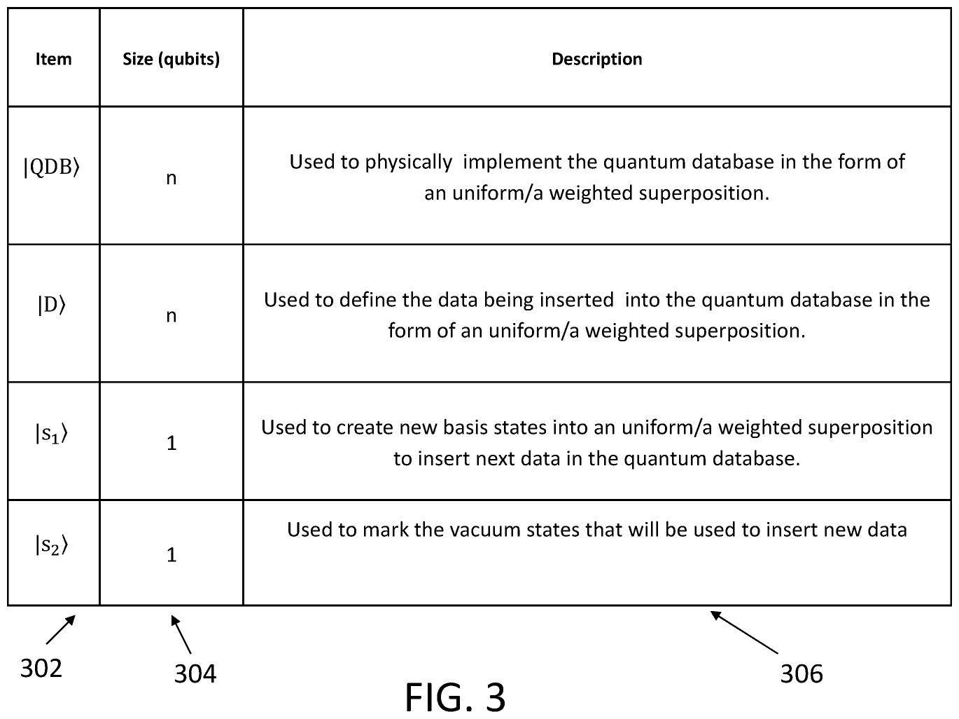

FIG. 3 is an example quantum information table that describes various features shown in FIG. 2.

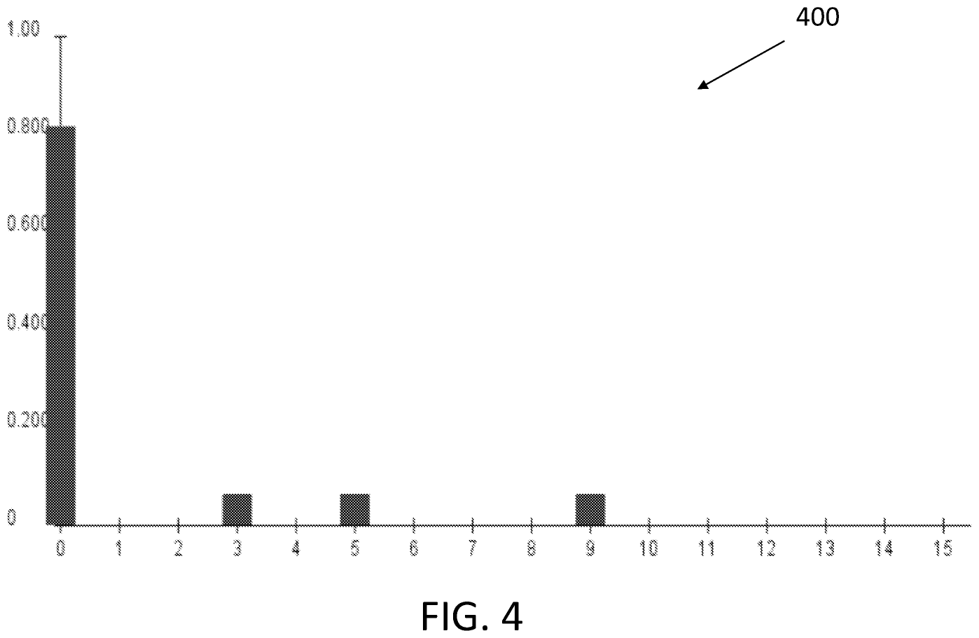

FIG. 4 is an example graph 400. In embodiments, graph 400 may be generated based on quantum inputs into a computing device, such as device 600 and generate graphs (based on a simulator, such as Javantum simulator) that represent simulations. In embodiments graph 400 displays state probabilities. In this non-limiting example, data is inserted into a database such that the state of the quantum database is as follows:

$$\vert QDB 〉 = \sqrt{\frac{13}{16}} \vert 0000 〉 + \sqrt{\frac{1}{16}} \vert 0011 〉 + \sqrt{\frac{1}{16}} \vert 0101 〉 + \sqrt{\frac{1}{16}} \vert 1001 〉 .$$

In this non-limiting example, a quantum circuit is applied three times to values {|0011 [symbol] , |0101 [symbol] , |1001 [symbol] } and graph 400 is generated. As shown in FIG. 4, graph 400 has an x-axis (horizontal axis) that represents a quantum basis states and a y-axis (vertical axis) that represents probability. Each bar represents probabilities occurring at various quantum basis states.

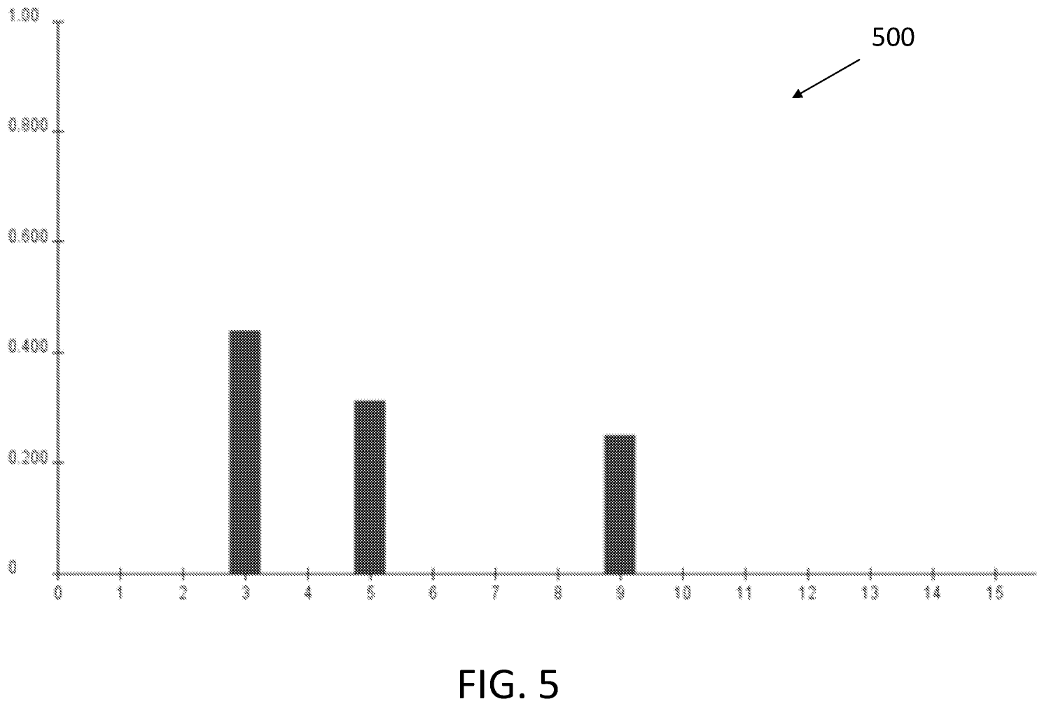

FIG. 5 is an example graph 500. In embodiments, graph 500 may be generated based on quantum inputs into a computing device, such as device 600 and generate graphs (based on a simulator, such as Javantum simulator) that represent simulations. In embodiments graph 500 displays probabilities of the basis states. In this non-limiting example, data is inserted into a weighted quantum database such that the state of the quantum database is as follows:

$$\vert QDB 〉 = \sqrt{\frac{7}{16}} \vert 0011 〉 + \sqrt{\frac{5}{16}} \vert 0101 〉 + \sqrt{\frac{4}{16}} \vert 1001 〉 .$$

In this non-limiting example, a quantum circuit is applied three times to values {|0011 [symbol] , |0101 [symbol] , |1001 [symbol] } and graph 500 is generated. As shown in FIG. 5, graph 500 has an x-axis (horizontal axis) that represents a quantum basis states and a y-axis (vertical axis) that represents probability. Each bar represents probabilities occurring at various quantum basis states.

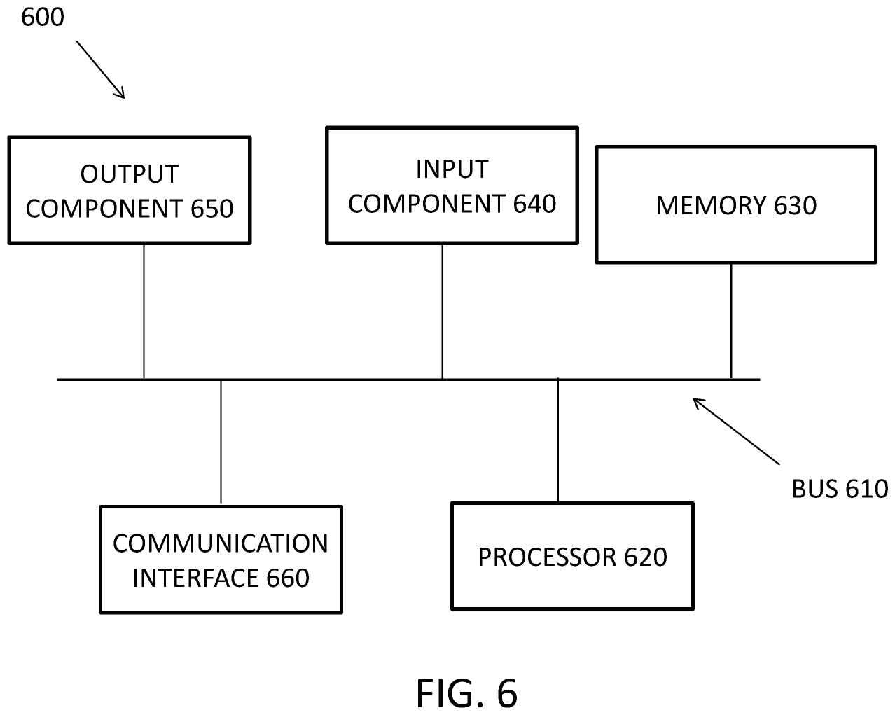

FIG. 6 is a diagram of example components of a device 600. Device 600 may correspond to a computing device, such as devices that may use systems 100 and/or 200. As shown in FIG. 6, device 600 may include a quantum bus 610, a quantum processor 620, a quantum memory 630, quantum input component 640, quantum output component 650, and a communications interface 660. In other implementations, device 600 may contain fewer components, additional components, different components, or differently arranged components than depicted in FIG. 6. Additionally, or alternatively, one or more components of device 600 may perform one or more tasks described as being performed by one or more other components of device 600.

Quantum bus 610 may include a path that permits communications among the components of device 600. Quantum processor 620 may include one or more processors, microprocessors, and/or processing logic (e.g., a field programmable gate array (FPGA), quantum teleportation devices, quantum communication devices, quantum computing circuits, quantum encryption applications and/or an application specific integrated circuit (ASIC)) that interprets and executes instructions. Input component 640 may include a mechanism that permits a user to convert classical information to quantum input information to device 600, such as a quantum circuit, a quantum-based application, a keyboard, a keypad, a button, a switch, voice command, etc. Quantum output component 650 may include a mechanism that outputs information and transforms quantum information to classical information to be provided to the user, such as a display, a speaker, one or more light emitting diodes (LEDs), etc.

Quantum communications interface 660 may include any transceiver-like mechanism that enables device 600 to communicate with other devices and/or systems. For example, communications interface 660 may include an Ethernet interface, an optical interface, a coaxial interface, a wireless interface, or the like and quantum-to-classical and vice versa unit.

In another implementation, quantum communications interface 660 may include, for example, a transmitter that may convert baseband signals from quantum processor 620 to radio frequency (RF) signals and/or a receiver that may convert RF signals to baseband signals. Alternatively, communications interface 660 may include a transceiver to perform functions of both a transmitter and a receiver of wireless communications (e.g., radio frequency, infrared, visual optics, quantum wireless, quantum channels, quantum fiber optics, quantum teleportation, quantum communication devices/networks, quantum encryption devices, etc.), wired communications (e.g., conductive wire, twisted pair cable, coaxial cable, transmission line, fiber optic cable, waveguide, single-photon channels, multi-photon channels, etc.), or a combination of wireless and wired communications.

Communications interface 660 may connect to an antenna assembly (not shown in FIG. 6) for transmission and/or reception of the RF signals, and/or quantum channels. The antenna assembly may include one or more antennas to transmit, quantum channels and/or receive RF signals over the air. The antenna assembly may, for example, receive RF signals and/or quantum information from communications interface 660 and transmit the RF signals over the air, and receive RF signals over the air and provide the RF signals to communications interface 660. In one implementation, for example, communications interface 660 may communicate with a network (e.g., a wireless network, quantum network, quantum channel, wired network, Internet, quantum internet, etc.). In embodiments, an antenna may be implemented by quantum teleportation protocols, quantum communication protocols and/or quantum encryption protocols.

As will be described in detail below, device 600 may perform certain operations. Device 600 may perform these operations in response to quantum processor 620 executing software instructions (e.g., computer program(s), quantum computing circuit, quantum teleportation, etc.) contained in a computer-readable medium/quantum-based computing, such as quantum memory 630, a secondary storage device (e.g., hard disk, CD-ROM, etc.), or other forms of RAM or ROM. A computer-readable medium may be defined as a non-transitory memory device. A memory device may include space within a single physical memory device or spread across multiple physical memory devices. The software instructions may be read into quantum memory 630 from another computer-readable medium or from another device. The software instructions contained in quantum memory 630 may cause quantum processor 620 to perform processes described herein. Alternatively, hardwired circuitry may be used in place of or in combination with software instructions to implement processes described herein. Thus, implementations described herein are not limited to any specific combination of hardware circuitry and software.

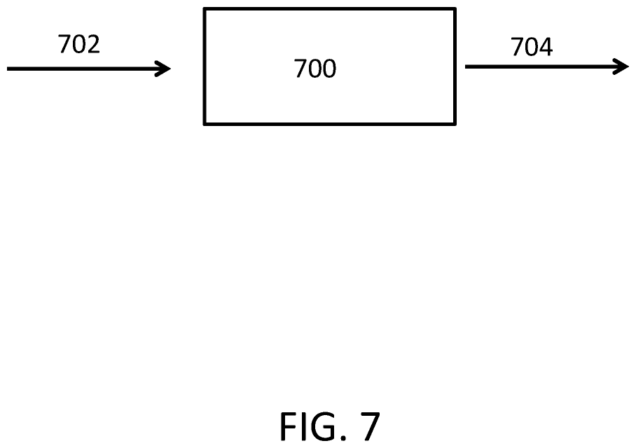

FIG. 7 is an example diagram of a computing device. FIG. 7 describes device 700, input 702, and output 704. In embodiments, device 700 may a computing device with features/structures similar to that described in FIG. 7. In embodiments, device 700 may be a computing device that is part of a laptop, desktop, tablet, smartphone, quantum computer, quantum computing device, quantum communication device, quantum internet device, and/or any other device. In embodiments, device 700 may include systems 100, and/or 200.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

While various actions are described as selecting, displaying, transferring, sending, receiving, generating, notifying, and storing, it will be understood that these example actions are occurring within an electronic computing, electronic networking, quantum database, quantum computing and/or quantum networking environment and may require one or more computing devices, as described in FIG. 6 or 7 to complete such actions. Furthermore, it will be understood that these various actions can be performed by using a touch screen on a computing device (e.g., touching an icon, swiping a bar or icon), using a keyboard, a mouse, or any other process for electronically selecting an option displayed on a display screen to electronically communicate with other computing devices, quantum computer, cloud, quantum communication devices, and/or quantum networks. Also, it will be understood that any of the various actions can result in any type of electronic information and/or quantum information to be displayed in real-time and/or simultaneously on multiple user devices. Any electronic graphs and/or quantum information may be generated by a computing device, such as device 600, and displayed via a graphical user device (GUI) or cloud environment.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A quantum method, comprising:
initializing, by the quantum circuit, three registers in a quantum circuit;
determining, by the quantum circuit, a value of αₖ;
if αₖ=M−Σ_{i=1,k-1}αᵢ=1, then the quantum method further comprises:
applying a set of size n of 3-qubit Toffli gate.

2. The quantum method of claim 1, wherein the registers include |QDB [symbol] , |S [symbol] , and |D [symbol] .

3. The quantum method of claim 2, wherein the register |D [symbol] is an input register with a particular number of qubits.

4. The quantum method of claim 2, wherein the register |QDB [symbol] represents a register of n qubits initialized with the vacuum state |000 . . . 0 [symbol] .

5. The quantum method of claim 2, wherein the register |S [symbol] represents a two qubit quantum control register initialized with state |01 [symbol] .

6. A quantum method, comprising:
initializing three registers in a quantum circuit;
determining, by the quantum circuit, a value of αₖ;
if αₖ≠M−Σ_{i=1,k-1}αᵢ=1, then the quantum method further comprising:
applying, by the quantum circuit, a set of size n of 3-qubit Toffoli gates so as to store new input data;
applying a set of size n of 3-qubit Toffli gate;
applying, by the quantum circuit, a S-operator;
applying, by the quantum circuit, a n+1-qubit Toffoli gate;
executing, by the quantum circuit, an IO Operator;
applying, again by the quantum circuit, the n+1-qubit Toffoli gate;
applying, again by the quantum circuit, the S-operator;
applying, again by the quantum circuit, the set of size n of 3-qubit Toffoli gates; and
determining, by the quantum circuit, whether to:
store a uniform superposition QDB, or
store a weighted superposition QDB.

7. The quantum method of claim 6, wherein the quantum circuit is associated with an insert operation for a quantum database.

8. The quantum method of claim 6, wherein insertion of the new input data results in a quantum database having the state of a weighted superposition in the form:
$$\vert QDB 〉 = {\sum }_{k} {α}_{k} \vert {D}_{k} 〉 ,$$
or a uniform superposition in the form
$$\vert QDB 〉 = \frac{1}{\sqrt{M}} {\sum }_{k} \vert {D}_{k} 〉$$

9. The quantum method of claim 6, wherein if the quantum circuit stores the uniform superposition QDB, then k=k+1 and the quantum method further comprising:
applying, again by the quantum circuit, the set of size n of 3-qubit Toffoli gates.

10. The quantum method of claim 6, wherein if the quantum circuit stores the weighted superposition QDB, then receive α_k as input and the quantum method further comprising:
applying, again by the quantum circuit, the set of size n of 3-qubit Toffoli gates.

11. The quantum method of claim 6, wherein the IO Operator is:
$$( \begin{matrix}1 & 0 & 0 & 0 \\ 0 & 1 & 0 & 0 \\ 0 & 0 & g & h \\ 0 & 0 & - h & g\end{matrix} )$$
